(19) United States
(12) Patent Application Publication
(10) Pub. No.: US 2023/0146685 A1
(43) Pub. Date: May 11, 2023

(54) CIRCUMFERENTIAL WELDING METHOD

(71) Applicant: Kabushiki Kaisha Kobe Seiko Sho (Kobe Steel, Ltd.), Kobe-shi (JP)

(72) Inventor: Masatoshi HIDA, Kobe-shi (JP)

(73) Assignee: Kabushiki Kaisha Kobe Seiko Sho (Kobe Steel, Ltd.), Kobe-shi (JP)

(21) Appl. No.: 17/906,958

(22) PCT Filed: Feb. 1, 2021
(86) PCT No.: PCT/JP2021/003601

§ 371 Date: Sep. 21, 2022

(30) Foreign Application Priority Data
Mar. 25, 2020 (JP) 2020-053638

(51) Int. Cl. B23K 9/127; B25J 9/16; B25J 11/00

(52) U.S. Cl. CPC B23K 9/127; B25J 9/1664; B25J 11/005

(57) ABSTRACT

A circumferential welding method is a method for circumferentially welding at least one of a V-shaped groove and an I-shaped groove by, using a vertical articulated robot, moving a welding torch with the welding torch directed downward. The circumferential welding is performed by moving the welding torch so as to draw a circular trajectory while adjusting a rotation angle of the welding torch in such a manner that a rotation center of a wrist of a robot main body of the vertical articulated robot is located at all times on a side where the robot main body is installed relative to the welding torch.

### TECHNICAL FIELD

The present invention relates to a method of performing circumferential welding by using a robot.

### BACKGROUND ART

A technique for welding by using a robot has been developed. For example, NPL 1 discloses a technique related to offline teaching for a welding robot.

A vertical articulated robot can move in a similar way to a human arm. For this reason, the use of the vertical articulated robot for welding enables precise welding. In the case of circumferential welding, the vertical articulated robot moves a welding torch along a weld line having a circumferential shape to perform welding. If the vertical articulated robot can move the welding torch in a circle along the weld line having the circumferential shape, welding can be continuously performed without suspending the welding during the circumferential welding.

In some cases, the vertical articulated robot cannot move the welding torch in a circle along the weld line having the circumferential shape due to, for example, an excessive motion angle range of an axis of the vertical articulated robot or a wound welding cable.

As for the circumferential welding by using the vertical articulated robot, it is considered that a teaching program for the trajectory of the motion of the robot is automatically produced by, for example, offline teaching. If a specified torch angle can be achieved with respect to tangential directions of four or more points on the weld line having the circumferential shape, the robot can have a posture at each point, but the axis of the robot moves beyond the motion angle range at front and rear points in some cases. In these cases, the vertical articulated robot cannot move the welding torch in a circle along the weld line having the circumferential shape.

When the vertical articulated robot cannot move the welding torch in a circle along the weld line having the circumferential shape, welding is performed with the weld line having the circumferential shape divided into multiple weld lines that have an arc shape. In this case, the welding is suspended during the circumferential welding. In some cases where the welding is suspended, a welding defect occurs at the position of suspension.

### CITATION LIST

### Non Patent Literature

NPL 1: Toshiyuki Izumi, the other three, “Automatic Teaching Technique for Offline Teaching System K-OTS”, [online], Kobe Steel Engineering Reports/Vol. 63 No. 1 (April 2013), pp. 94-98, [searched on February 28, Reiwa 2], Internet <URL:https://www.kobelco.co.jp/technology-review/pdf/63_1/094-098.pdf

### SUMMARY OF INVENTION

The present invention has been accomplished in view of the above circumstances, and it is an object of the present invention to provide a circumferential welding method that enables welding to be continuously performed without suspending the welding during circumferential welding.

A circumferential welding method according to an aspect of the present invention is a circumferential welding method for performing circumferential welding of at least one of a V-shaped groove and an I-shaped groove while a welding torch is moved with the welding torch having a downward posture by using a vertical articulated robot. The circumferential welding is performed while a rotation angle of the welding torch is adjusted such that a wrist rotation center of a robot body of the vertical articulated robot is always located closer to a position at which the robot body is installed than the welding torch is, and the welding torch is moved so as to draw a circular trajectory.

The object described above, another object, features, and advantages of the present invention will be clarified from the following detailed description and drawings below.

### BRIEF DESCRIPTION OF DRAWINGS

FIG. 1 schematically illustrates an example of a vertical articulated robot for which a circumferential welding method according to an embodiment is used.

FIG. 2 is a schematic diagram in which the posture of a welding torch is changed by changing a torch rotation angle.

FIG. 3A illustrates an image when the welding torch is located at a first position during the motion of the welding torch that moves in a circle along a weld line in a simulation for a circumferential welding method according to a first embodiment.

FIG. 3B illustrates an image when the welding torch is located at a second position during the motion.

FIG. 3C illustrates an image when the welding torch is located at a third position during the motion.

FIG. 3D illustrates an image when the welding torch is located at a fourth position during the motion.

FIG. 4A illustrates an image when the welding torch is located at a first position during the motion of the welding torch that moves in a circle along the weld line in a simulation for a circumferential welding method according to a second embodiment.

FIG. 4B illustrates an image when the welding torch is located at a second position during the motion.

FIG. 4C illustrates an image when the welding torch is located at a third position during the motion.

FIG. 4D illustrates an image when the welding torch is located at a fourth position during the motion.

FIG. 5A illustrates an image when the welding torch is located at a first position during the motion of the welding torch that moves in a circle along the weld line in a simulation for a circumferential welding method according to a third embodiment.

FIG. 5B illustrates an image when the welding torch is located at a second position during the motion.

FIG. 5C illustrates an image when the welding torch is located at a third position during the motion.

FIG. 5D illustrates an image when the welding torch is located at a fourth position during the motion.

FIG. 6 schematically illustrates a diagram for description of setting a position at which a robot body is installed in a circumferential welding method according to a fourth embodiment.

FIG. 7 schematically illustrates a diagram for description of setting the position at which the robot body is installed in a circumferential welding method according to a fifth embodiment.

FIG. 8 illustrates a flowchart illustrating a process of selecting circumferential welding according to the first to fifth embodiments.

### DESCRIPTION OF EMBODIMENTS

One or multiple embodiments of the present invention will hereinafter be described with reference to the drawings. However, the range of the invention is not limited to the disclosed one or multiple embodiments. Structures designated by like reference characters in the drawings are like structures, and the description thereof is appropriately omitted. In the present specification, general terms are designated by reference characters in which subscripts are omitted, and individual structures are designated by reference characters including subscripts.

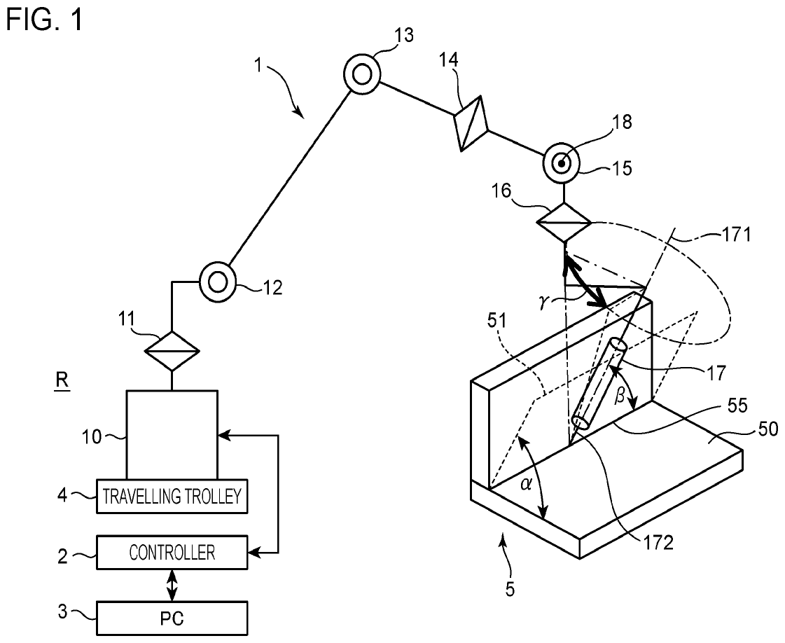

A circumferential welding method according to an embodiment is used for a vertical articulated robot R. FIG. 1 schematically illustrates an example of the vertical articulated robot R for which the circumferential welding method according to the embodiment is used. The vertical articulated robot R includes a robot body 1 (a manipulator), a controller 2, and a personal computer (a PC) 3.

The robot body 1 is illustrated as a framework. The robot body 1 has a six-shaft structure in which shafts are provided in the order of a first shaft 11, a second shaft 12, a third shaft 13, a fourth shaft 14, a fifth shaft 15, and a sixth shaft 16 from a robot cradle 10 to an end (an end effector) of the robot body 1. The end effector is a welding torch 17. A welding wire 172 extends from an end of the welding torch 17.

The rotation axis of the first shaft 11 enables rotation in a vertical axis direction. The rotation axis of the second shaft 12 mainly enables forward and backward movement. The rotation axis of the third shaft 13 mainly enables upward and downward movement. The rotation axis of the fourth shaft 14 enables rotation in a longitudinal direction. The rotation axis of the fifth shaft 15 enables upward and downward bending. The rotation axis of the sixth shaft 16 enables the end effector to rotate. The vertical articulated robot R for which the circumferential welding method according to the embodiment is used is not limited by the six-shaft structure, but the number of the shafts may be increased (for example, a seven-shaft structure).

The posture (the welding posture) of the welding torch 17 is decided by using a torch inclination angle α, a torch advancing-receding angle β, and a torch rotation angle γ. The torch inclination angle α is an angle between a reference surface 50 of a workpiece 5 to be welded and an imaginary plane 51 (an inclination angle based on a weld line). The imaginary plane 51 has a side corresponding to a weld line 55, and a center line 171 (the axis) of the welding torch 17 is located on the imaginary plane 51. The torch advancing-receding angle β is an angle between the weld line 55 and the center line 171. The torch rotation angle γ is an angle when the welding torch 17 rotates about the center line 171 (an angle at which the end of the welding torch 17 rotates, or the rotation angle of the welding torch 17). The torch inclination angle α, the torch advancing-receding angle β, and the torch rotation angle γ are adjusted by using the rotation angle of the fourth shaft 14, the rotation angle of the fifth shaft 15, and the rotation angle of the sixth shaft 16. Accordingly, the posture (the welding posture) of the welding torch 17 is decided by using the rotation angle of the fourth shaft 14, the rotation angle of the fifth shaft 15, and the rotation angle of the sixth shaft 16.

A wrist rotation center 18 corresponds to a point at which an imaginary line that extends from the center line of the rotation axis of the fourth shaft 14, the center line of the rotation axis of the fifth shaft 15, and an imaginary line that extends from the center line of the rotation axis of the sixth shaft 16 meet.

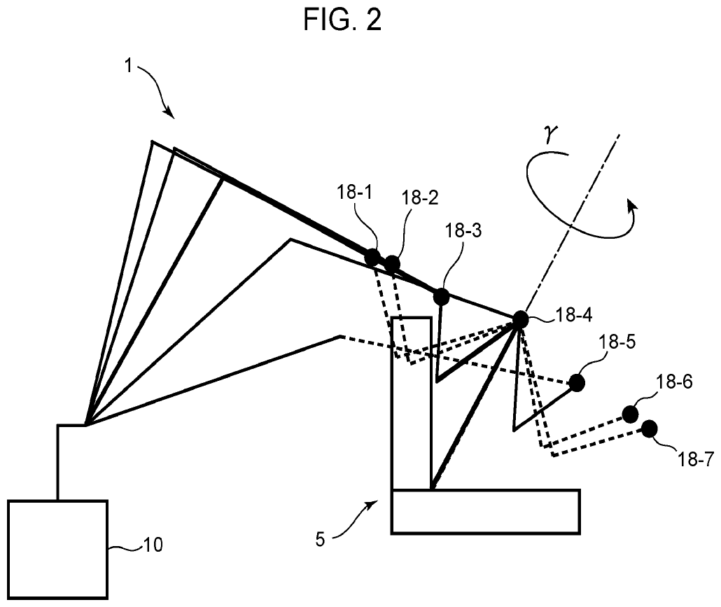

The direction of the welding torch 17 is decided by using the torch inclination angle α and the torch advancing-receding angle β. After the direction of the welding torch 17 is decided, welding can be performed, and accordingly, the torch rotation angle γ can be freely set. The position of the wrist rotation center 18 is changed by changing the torch rotation angle γ. This enables the posture of the welding torch 17 to be changed and enables the posture of the robot body 1 to be changed. FIG. 2 schematically illustrates this.

As for wrist rotation centers 18-3 and 18-4, the arm of the robot body 1 does not interfere with the workpiece 5, and the arm of the bot body 1 can reach the weld line 55 (FIG. 1) (welding can be performed). As for wrist rotation centers 18-6 and 18-7, the arm of the robot body 1 does not interfere with the workpiece 5, but the arm of the robot body 1 cannot reach the weld line 55 (welding cannot be performed). As for wrist rotation centers 18-1, 18-2, and 18-5, the arm of the robot body 1 interferes with the workpiece 5 (welding cannot be performed).

Referring to FIG. 1, the robot body 1 is placed on a travelling trolley 4, and the position at which the robot body 1 is installed can be changed by moving the travelling trolley 4. The position at which the robot body 1 is installed may be changed by a crane instead of the travelling trolley 4. The controller 2 is a device that includes various kinds of substrates for controlling the motion of the robot body 1. The travelling trolley 4 may be controlled by the controller 2 or may be controlled by another control device that differs from the controller 2. The PC 3 is a computer that is used for offline teaching. Offline teaching data (an offline teaching program) that is generated by the PC 3 for the robot body 1 is transferred from the PC 3 to the controller 2. The controller 2 controls the motion of the robot body 1 in accordance with the offline teaching data.

Embodiments include a first embodiment to a fifth embodiment. A circumferential welding method according to the first embodiment will now be described.

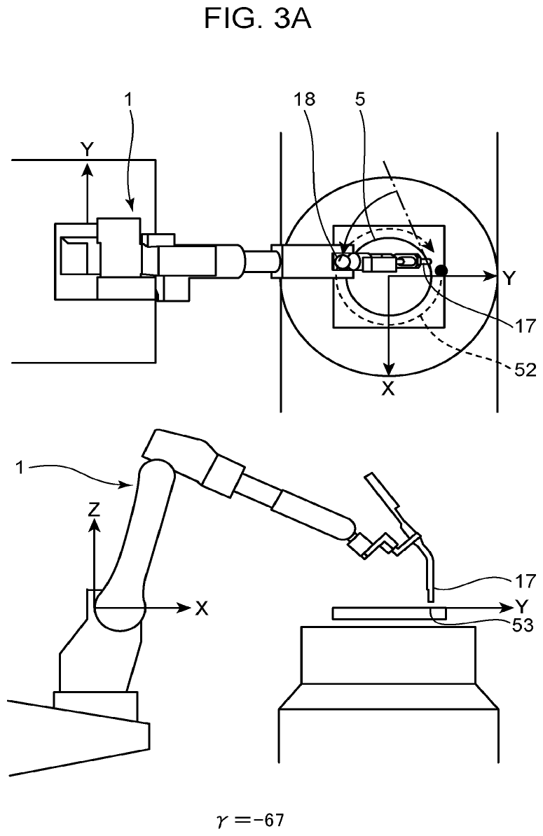

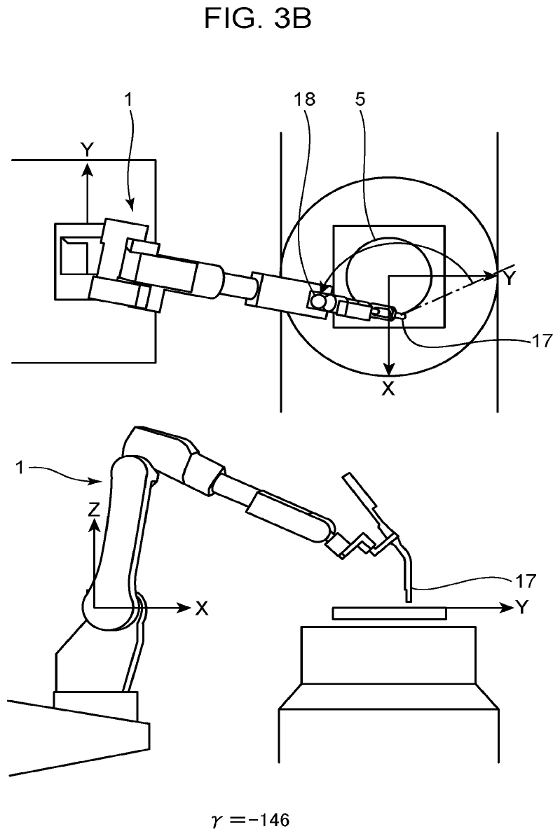

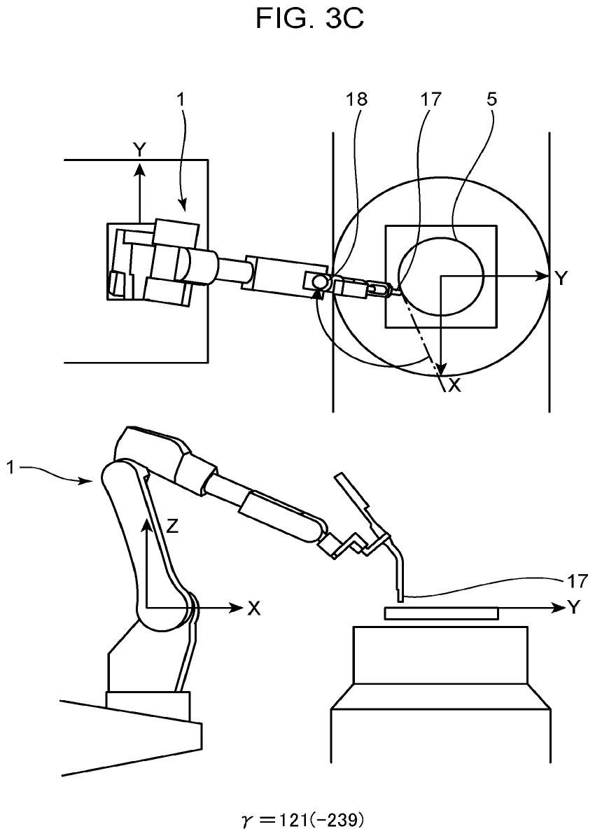

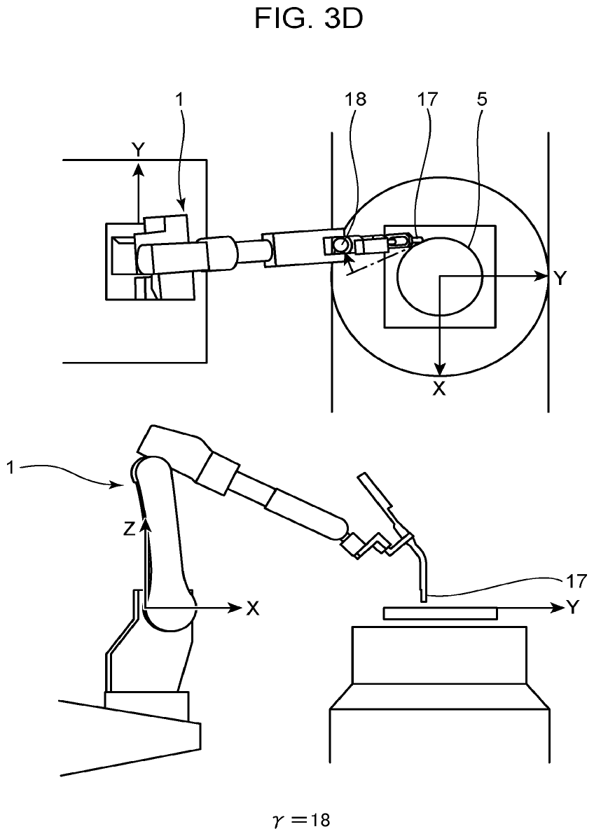

FIG. 3A to FIG. 3D illustrate images of the motion of the welding torch 17 that moves in a circle along a weld line 52 in a simulation for the circumferential welding method according to the first embodiment. FIG. 3A illustrates the case where the welding torch 17 is located at a first position. FIG. 3B illustrates the case where the welding torch 17 is located at a second position. FIG. 3C illustrates the case where the welding torch 17 is located at a third position. FIG. 3D illustrates the case where the welding torch 17 is located at a fourth position. Images when the robot body 1 and the workpiece 5 are viewed from above are illustrated at upper parts in FIG. 3A to FIG. 3D. Images when the robot body 1 and the workpiece 5 are viewed sideways are illustrated at lower parts in FIG. 3A to FIG. 3D.

The weld line 52 has a circumferential shape and is located on a horizontal plane. The coordinates of the vertical articulated robot R (the robot body 1) are three-dimensional coordinates (an x-axis, a y-axis, and a z-axis). The coordinates of the workpiece 5 are two-dimensional coordinates (the x-axis and the y-axis). The same is true for the second to fifth embodiments.

The circumferential welding method according to the first embodiment is used in the case where the circumferential welding of at least one of a V-shaped groove and an T-shaped groove is performed while the welding torch 17 is moved with the welding torch 17 having a downward posture by using the vertical articulated robot R. In the circumferential welding method according to the first embodiment in this case, as illustrated in FIG. 3A to FIG. 3D, the circumferential welding is performed while the torch rotation angle γ (the rotation angle of the welding torch 17) is adjusted such that the wrist rotation center 18 of the robot body 1 is always located closer to the position at which the robot body 1 is installed (in other words, to a robot starting point) than the welding torch 17 is, and the welding torch 17 is moved so as to draw a circular trajectory.

The position when the torch rotation angle γ is 0° is a position in a tangential direction of a circle illustrated by a one-dot chain line, and accordingly, the torch rotation angle γ to be set is an angle from this tangent to the position of the wrist rotation center 18. FIG. 3A illustrates a state when the torch rotation angle γ is −67°. FIG. 3B illustrates a state when the torch rotation angle γ is −146°. FIG. 3C illustrates a state when the torch rotation angle γ is 121° (−239°). FIG. 3D illustrates a state when the torch rotation angle γ is 18°. In FIG. 3A to FIG. 3D, for example, α is 90°, and β is 90°.

The present inventor has found that the vertical articulated robot R enables the welding torch 17 to move in a circle along the weld line 52 having the circumferential shape when the vertical articulated robot R operates in this way. As illustrated in FIG. 3A to FIG. 3D, it can be seen that the welding torch 17 moves in a circle along the weld line 52 having the circumferential shape, and the robot body 1 does not have an unreasonable posture. In the above description, the welding torch 17 moves in a circle clockwise but may move in a circle counterclockwise.

The circumferential welding method according to the first embodiment thus enables welding to be continuously performed without suspending the welding during the circumferential welding.

The present inventor has found that the circumferential welding method according to the first embodiment enables the start-end position 53 of the circumferential welding to be freely set. Accordingly, the vertical articulated robot R enables the welding torch 17 to move in a circle along the weld line 52 having the circumferential shape regardless of the start-end position 53 of the circumferential welding and enables the degree of freedom of the circumferential welding to be increased.

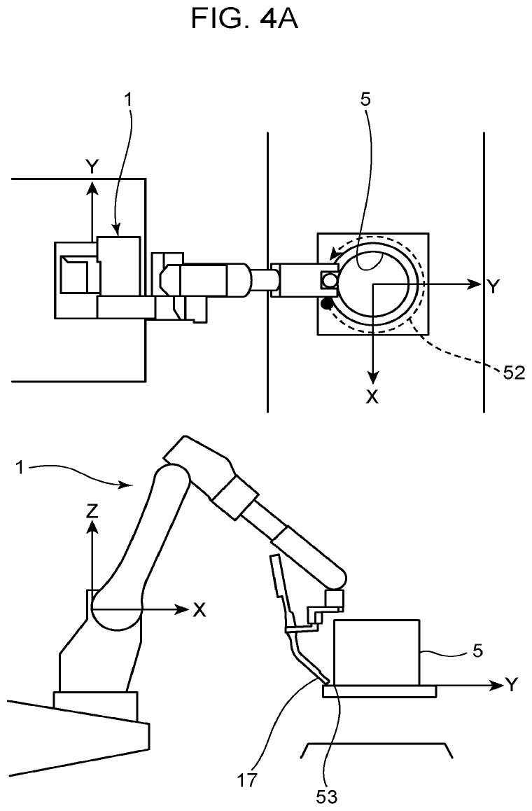

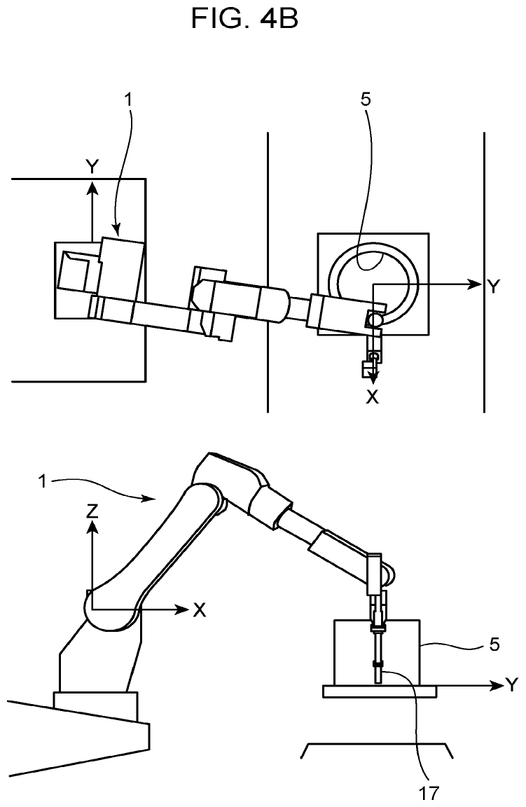

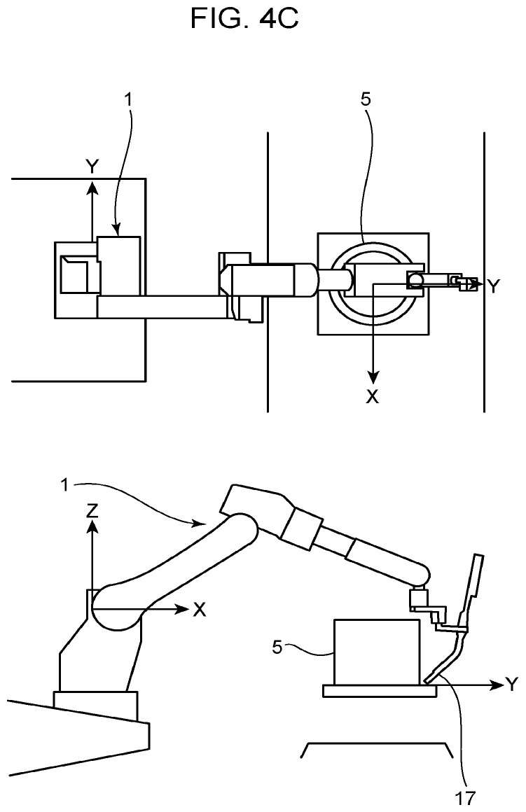

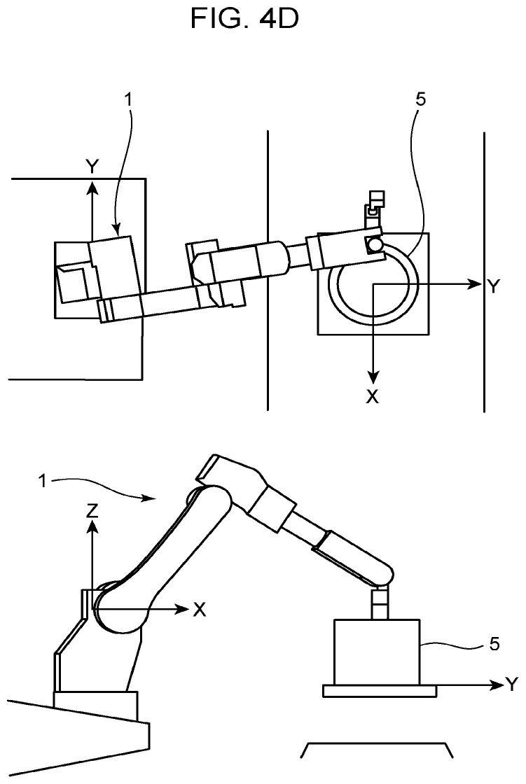

A circumferential welding method according to the second embodiment will be described. FIG. 4A to FIG. 4D illustrate images of the motion of the welding torch 17 that moves in a circle along the weld line 52 in a simulation for the circumferential welding method according to the second embodiment. FIG. 4A illustrates the case where the welding torch 17 is located at a first position. FIG. 4B illustrates the case where the welding torch 17 is located at a second position. FIG. 4C illustrates the case where the welding torch 17 is located at a third position. FIG. 4D illustrates the case where the welding torch 17 is located at a fourth position. Images when the robot body 1 and the workpiece 5 are viewed from above are illustrated at upper parts in FIG. 4A to FIG. 4D. Images when the robot body 1 and the workpiece 5 are viewed sideways are illustrated at lower parts in FIG. 4A to FIG. 4D.

The circumferential welding method according to the second embodiment is used in the case where fillet welding is performed on the outside of the workpiece 5 over the entire circumference. This is an example in which the circumferential welding is performed while the welding torch 17 is moved with the welding torch 17 located outside the weld line 52 and with the welding torch 17 inclined in a left-right direction with respect to the weld line 52 by using the vertical articulated robot R.

As for the circumferential welding in this case, when the vertical articulated robot R moves the welding torch 17 in a circle along the weld line 52 having the circumferential shape, the range of an angle at which the sixth shaft 16 (FIG. 1) rotates is larger than the ranges of angles at which the other shafts rotate. The range of an angle at which the sixth shaft 16 is permitted to rotate is decided in advance (for example, at least ±180° such as ±180° or ±200°) in order to prevent a welding cable from being wound. In some cases, the range of the angle at which the sixth shaft 16 rotates exceeds the range of the angle at which the sixth shaft 16 is permitted to rotate depending on where the start-end position 53 of the circumferential welding is set to. The circumferential welding method according to the second embodiment enables this to be avoided (the same is true for a circumferential welding method according to the third embodiment) as described below.

As illustrated in FIG. 4A to FIG. 4D, in the circumferential welding method according to the second embodiment, the start-end position 53 of the circumferential welding is set to a position on the weld line 52 nearest to the position at which the robot body 1 is installed (in other words, the robot starting point), and the circumferential welding is performed while the welding torch 17 is moved so as to draw a circular trajectory. During the circumferential welding, the end of the welding torch 17 always overlaps the wrist rotation center 18 (the torch rotation angle γ=−90°) by using the robot body 1, but this is not essential. By way of example, FIG. 4A to FIG. 4D illustrate states in which α is 45°, β is 90°, and γ is 90° (α is 135°, β is 90°, and γ is −90° in the case of the opposite welding direction) as torch angles with respect to welding coordinates in the tangential direction at each position.

The present inventor has found that the vertical articulated robot R enables the welding torch 17 to move in a circle along the weld line 52 having the circumferential shape when the vertical articulated robot R operates in this way (found that the range of the angle at which the sixth shaft 16 rotates does not exceed the range of the angle at which the sixth shaft 16 is permitted to rotate). As illustrated in FIG. 4A to FIG. 4D, it can be seen that the welding torch 17 moves in a circle along the weld line 52 having the circumferential shape, and the robot body 1 does not have an unreasonable posture. In the above description, the welding torch 17 moves in a circle counterclockwise but may move in a circle clockwise.

The circumferential welding method according to the second embodiment thus enables welding to be continuously performed without suspending the welding during the circumferential welding.

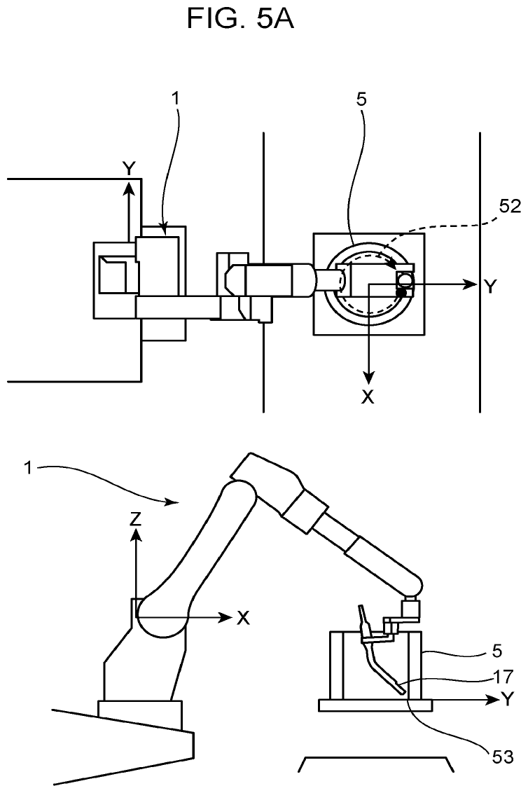

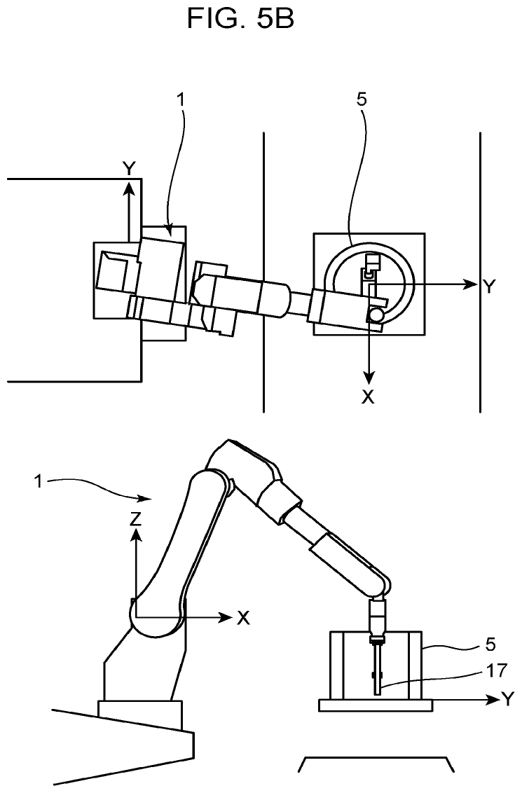

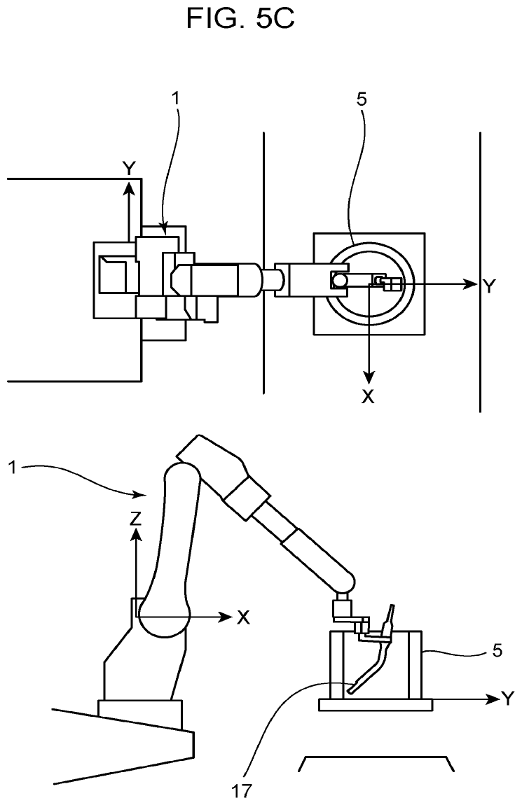

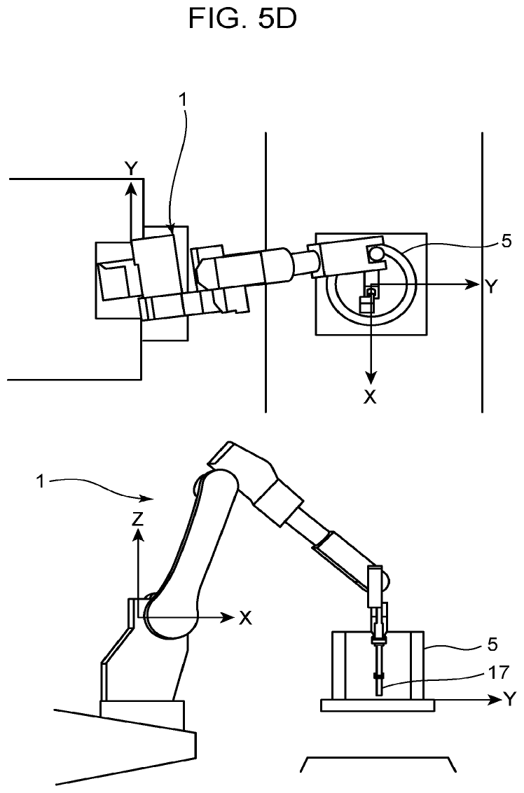

The circumferential welding method according to the third embodiment will be described. FIG. 5A to FIG. 5D illustrate images of the motion of the welding torch 17 that moves in a circle along the weld line 52 in a simulation for the circumferential welding method according to the third embodiment. FIG. 5A illustrates the case where the welding torch 17 is located at a first position. FIG. 5B illustrates the case where the welding torch 17 is located at a second position. FIG. 5C illustrates the case where the welding torch 17 is located at a third position. FIG. 5D illustrates the case where the welding torch 17 is located at a fourth position. Images when the robot body 1 and the workpiece 5 are viewed from above are illustrated at upper parts in FIG. 5A to FIG. 5D. Images when the robot body 1 and the workpiece 5 are viewed sideways are illustrated at lower parts in FIG. 5A to FIG. 5D.

The circumferential welding method according to the third embodiment is used in the case where the fillet welding is performed on the inside of the workpiece 5 over the entire circumference. This is an example in which the circumferential welding is performed while the welding torch 17 is moved with the welding torch 17 located inside the weld line 52 and with the welding torch 17 inclined in the left-right direction with respect to the weld line 52 by using the vertical articulated robot R.

As illustrated in FIG. 5A to FIG. 5D, in the circumferential welding method according to the third embodiment, the start-end position 53 of the circumferential welding is set to a position on the weld line 52 farthest from the position at which the robot body 1 is installed (in other words, the robot starting point), and the circumferential welding is performed while the welding torch 17 is moved so as to draw a circular trajectory. During the circumferential welding, the end of the welding torch 17 always overlaps the wrist rotation center 18 (the torch rotation angle γ=−90°) by using the robot body 1, but this is not essential. By way of example, FIG. 5A to FIG. 5D illustrate states in which α is 45°, β is 90°, and γ is 90° (α is 135°, β is 90°, and γ is −90° in the case of the opposite welding direction) as the torch angles with respect to the welding coordinates in the tangential direction at each position.

The present inventor has found that the vertical articulated robot R enables the welding torch 17 to move in a circle along the weld line 52 having the circumferential shape when the vertical articulated robot R operates in this way (found that the range of the angle at which the sixth shaft 16 rotates does not exceed the range of the angle at which the sixth shaft 16 is permitted to rotate). As illustrated in FIG. 5A to FIG. 5D, it can be seen that the welding torch 17 moves in a circle along the weld line 52 having the circumferential shape, and the robot body 1 does not, have an unreasonable posture. In the above description, the welding torch 17 moves in a circle clockwise but may move in a circle counterclockwise.

The circumferential welding method according to the third embodiment thus enables welding to be continuously performed without suspending the welding during the circumferential welding.

A circumferential welding method according to the fourth embodiment will be described. According to the fourth embodiment, the circumferential welding is performed in the same manner as in the second embodiment by changing the position at which the robot body 1 is installed (in other words, the robot starting point). FIG. 4A to FIG. 4D illustrate the case where the fillet welding is performed on the outside of the workpiece 5 over the entire circumference by using the vertical articulated robot R as described according to the second embodiment. This is an example in which the circumferential welding is performed while the welding torch 17 is moved with the welding torch 17 located outside the weld line 52 and with the welding torch 17 inclined in the left-right direction with respect to the weld line 52 by using the vertical articulated robot R. In this case, the start-end position 53 of the circumferential welding is set to the position on the weld line 52 nearest to the position at which the robot, body 1 is installed, and the circumferential welding is performed while the welding torch 17 is moved so as to draw a circular trajectory as described according to the second embodiment.

When the start-end position 53 of the circumferential welding has been decided, and this position is not the nearest position described above, the circumferential welding method according to the second embodiment cannot be performed. According to the fourth embodiment, the position at which the robot body 1 is installed is changed such that the start-end position 53 of the circumferential welding becomes the nearest position by using the travelling trolley 4 on which the robot body 1 is placed.

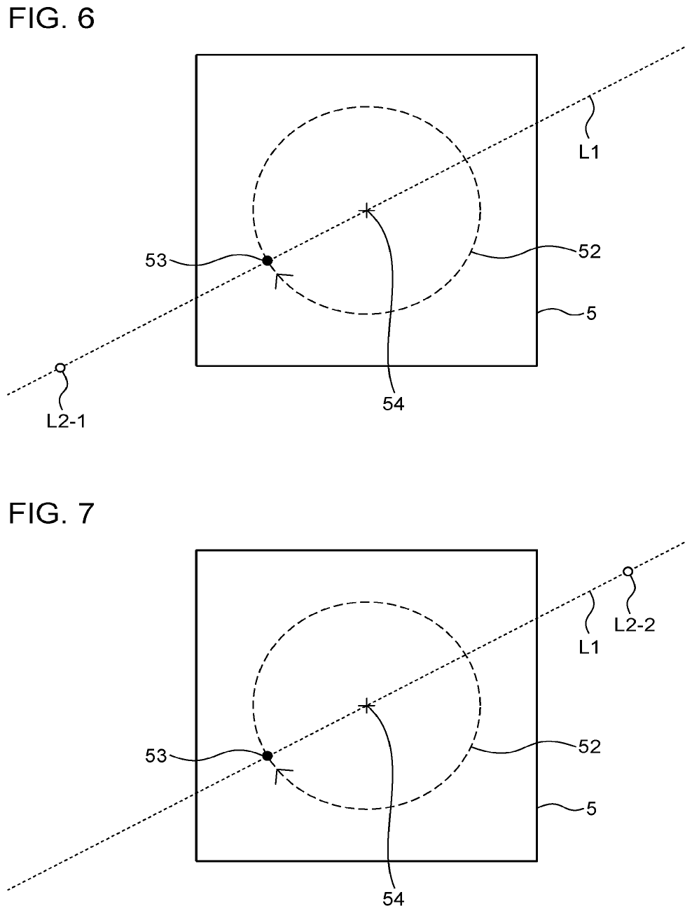

FIG. 6 schematically illustrates a diagram for description of setting the position at which the robot body 1 is installed in the circumferential welding method according to the fourth embodiment. The weld line 52 having the circumferential shape is provided for the workpiece 5. A first imaginary line L1 passes through a center 54 of the weld line 52 having the circumferential shape and the start-end position 53 of the circumferential welding. A second imaginary line L2-1 intersects the first imaginary line L1 in the vertical direction outside the weld line 52 having the circumferential shape and has a distance from the start-end position 53 shorter than a distance from the center 54. The position at which the robot body 1 is installed (in other words, the robot, starting point) is set on the second imaginary line L2-1. The second imaginary line L2-1 is perpendicular to the page in FIG. 6, and the second imaginary line L2-1 is illustrated by a point (O) in FIG. 6.

In the circumferential welding method according to the fourth embodiment, the robot body 1 is installed at the position of installation described above, and the circumferential welding is performed while the welding torch 17 is moved so as to draw a circular trajectory. This enables welding to be continuously performed without suspending the welding during the circumferential welding. The fourth embodiment is effective in the case where the start-end position 53 of the circumferential welding cannot be changed.

A circumferential welding method according to the fifth embodiment will be described. According to the fifth embodiment, the circumferential welding is performed in the same manner as in the third embodiment by changing the position at which the robot body 1 is installed (in other words, the robot starting point). FIG. 5A to FIG. 5D illustrate the case where the fillet welding is performed on the inside of the workpiece 5 over the entire circumference by using the vertical articulated robot R as described according to the third embodiment. This is an example in which the circumferential welding is performed while the welding torch 17 is moved with the welding torch 17 located inside the weld line 52 and with the welding torch 17 inclined in the left-right direction with respect to the weld line 52 by using the vertical articulated robot R. In this case, the start-end position 53 of the circumferential welding is set to the position on the weld line 52 farthest from the position at which the robot body 1 is installed, and the circumferential welding is performed while the welding torch 17 is moved so as to draw a circular trajectory as described according to the third embodiment.

When the start-end position 53 of the circumferential welding has been decided, and this position is not the farthest position described above, the circumferential welding method according to the third embodiment cannot be performed. According to the fifth embodiment, the position at which the robot body 1 is installed is changed such that the start-end position 53 of the circumferential welding becomes the farthest position by using the travelling trolley 4 on which the robot body 1 is placed.

FIG. 7 schematically illustrates a diagram for description of setting the position at which the robot body 1 is installed in the circumferential welding method according to the fifth embodiment. A difference in FIG. 7 from FIG. 6 is the position of a second imaginary line L2-2. The second imaginary line L2-2 intersects the first imaginary line L1 in the vertical direction outside the weld line 52 having the circumferential shape and has a distance from the center 54 shorter than a distance from the start-end position 53. The position at which the robot body 1 is installed (in other words, the robot starting point) is set on the second imaginary line L2-2. The second imaginary line L2-2 is perpendicular to the page in FIG. 7, and the second imaginary line L2-2 is illustrated by a point (O) in FIG. 7.

In the circumferential welding method according to the fifth embodiment, the robot body 1 is installed at the position of installation described above, and the circumferential welding is performed while the welding torch 17 is moved so as to draw a circular trajectory. This enables welding to be continuously performed without suspending the welding during the circumferential welding. The fifth embodiment is effective in the case where the start-end position 53 of the circumferential welding cannot be changed.

The circumferential welding according to the first to fifth embodiments is performed based on the offline teaching data. The offline teaching data is data (a program) for performing the circumferential welding by using the vertical articulated robot R and contains information required for selecting the circumferential welding according to the first to fifth embodiments. Specifically, the information contains the welding posture (such as the downward posture or a sideways posture), the kind of a welding seam (such as butt welding or the fillet welding), the kind of the groove (such as the V-shaped groove, the I-shaped groove, a K-shaped groove, or an X-shaped groove), whether the start-end position 53 of the circumferential welding has been decided, and the kind of the fillet welding. The kind of the fillet welding is information that represents whether the outside of the workpiece 5 is welded or the inside of the workpiece 5 is welded in the case of the fillet welding.

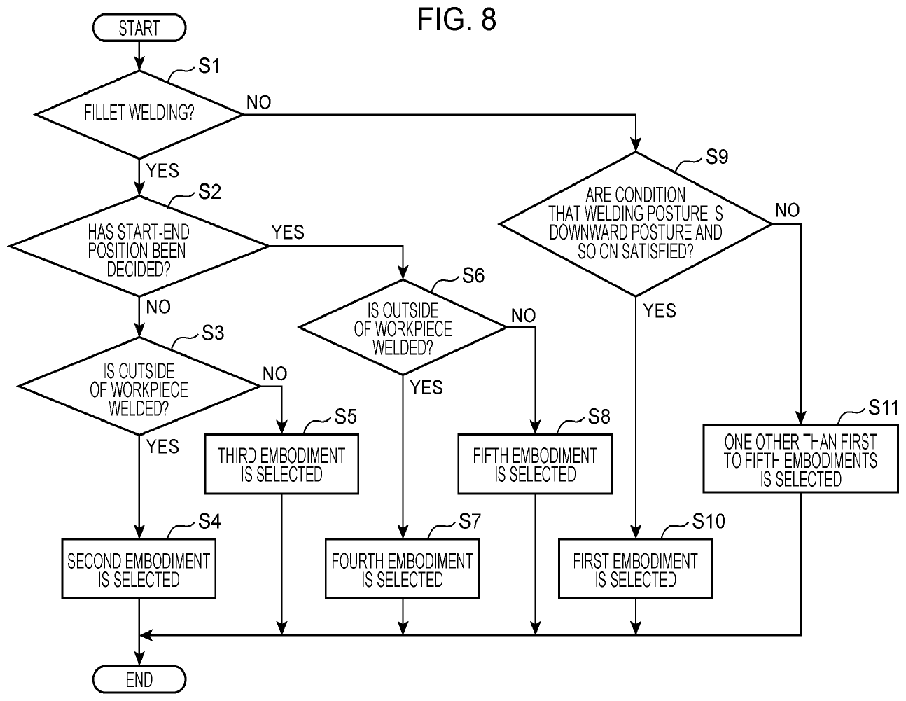

FIG. 8 illustrates a flowchart illustrating a process of selecting the circumferential welding according to the first to fifth embodiments. Referring to FIG. 1 and FIG. 8, the controller 2 refers the offline teaching data and determines whether the fillet welding is performed (S1). If it is determined that the fillet welding is performed (Yes at S1), the controller 2 refers the offline teaching data and determines whether the start-end position 53 of the circumferential welding has been decided (S2).

If it is determined that the start-end position 53 of the circumferential welding has not been decided (No at S2), the controller 2 refers the offline teaching data and determines whether the fillet welding is welding of the outside of the workpiece 5 (S3). That is, it is determined that the fillet welding is welding of the outside of the workpiece 5 or the fillet welding is welding of the inside of the workpiece 5.

If it is determined that the outside of the workpiece 5 is welded (Yes at S3), the controller 2 selects the circumferential welding method according to the second embodiment described with reference to FIG. 4A to FIG. 4D and performs the circumferential welding method according to the second embodiment, based on the offline teaching data (S4).

If it is determined that the outside of the workpiece 5 is not welded (No at S3), that is, if it is determined that the inside of the workpiece 5 is welded, the controller 2 selects the circumferential welding method according to the third embodiment described with reference to FIG. 5A to FIG. 5D and performs the circumferential welding method according to the third embodiment, based on the offline teaching data (S5).

If it is determined that the start-end position 53 of the circumferential welding has been decided (Yes at S2), the controller 2 refers the offline teaching data and determines whether the fillet welding is welding of the outside of the workpiece 5 (SW. That is, it is determined whether the fillet welding is welding of the outside of the workpiece 5 or the fillet welding is welding of the inside of the workpiece 5.

If it is determined that the outside of the workpiece 5 is welded (Yes at S6), the controller 2 selects the circumferential welding method according to the fourth embodiment, described with reference to FIG. 6 and performs the circumferential welding method according to the fourth embodiment, based on the offline teaching data (S7).

If it is determined that the outside of the workpiece 5 is not welded, (No at SW, that is, if it is determined that the inside of the workpiece 5 is welded, the controller 2 selects the circumferential welding method according to the fifth embodiment described with reference to FIG. 7 and performs the circumferential welding method according to the fifth embodiment, based on the offline teaching data (S8).

If it is determined that the fillet welding is not performed, (No at S1), the controller 2 refers the offline teaching data and determines whether conditions that the welding posture is the downward posture, the kind of the welding seam is the butt welding, and the kind of the groove is at least one of the V-shaped groove and the I-shaped groove are satisfied (S9). If it is determined that the conditions are satisfied (Yes at S9), the controller 2 selects the circumferential welding method according to the first embodiment described with reference to FIG. 3A to FIG. 3D and performs the circumferential welding method according to the first embodiment, based on the offline teaching data (S10). If it is determined that the conditions are not satisfied (No at S9), the controller 2 selects a circumferential welding method that differs from those according to the first, to fifth embodiments (S11).

The present specification discloses techniques in various aspects as described above. Among these, main techniques are summarized below.

A circumferential welding method according to an aspect is a circumferential welding method for performing the circumferential welding of at least one of a V-shaped groove and an I-shaped groove while a welding torch is moved with the welding torch having a downward posture by using a vertical articulated robot. The circumferential welding is performed while a rotation angle of the welding torch is adjusted such that a wrist rotation center of a robot body of the vertical articulated robot is always located closer to a position at which the robot body is installed than the welding torch is, and the welding torch is moved so as to draw a circular trajectory.

In the case of the vertical articulated robot that has the six-shaft structure, the rotation axis of the first shaft of the robot body enables rotation in the vertical axis direction, the rotation axis of the second shaft mainly enables the forward and backward movement, the rotation axis of the third shaft mainly enables the upward and downward movement, the rotation axis of the fourth shaft enables the rotation in the longitudinal direction, the rotation axis of the fifth shaft enables the upward and downward bending, and the rotation axis of the sixth shaft enables the end effector to rotate.

The wrist rotation center corresponds to the point at which the imaginary line that extends from the center line of the rotation axis of the fourth shaft, the center line of the rotation axis of the fifth shaft, and the imaginary line that extends from the center line of the rotation axis of the sixth shaft meet. The rotation angle of the welding torch is the angle when the welding torch rotates about the central axis (the longitudinal direction) of the welding torch.

In the case where the circumferential welding of at least one of the V-shaped groove and the I-shaped groove is performed while the welding torch is moved with the welding torch having the downward posture by using the vertical articulated robot, the same posture of the welding torch is typically maintained with respect to a circumferential tangential direction. For this reason, the welding torch rotates about the axis of the welding torch as the position of welding changes along the circumference, and the posture of the robot body has an unreasonable posture. To avoid this, it is necessary to take a measure for rotating the welding torch about the axis of the welding torch and for preventing the welding torch from having an unreasonable posture. The present inventor has found that the vertical articulated robot enables the welding torch to move in a circle along the weld line having the circumferential shape by performing the circumferential welding method described above. Accordingly, the circumferential welding method described above enables welding to be continuously performed without suspending the welding during the circumferential welding.

The circumferential welding method described above enables the start-end position of the circumferential welding to be freely set. Accordingly, the vertical articulated robot enables the welding torch to move in a circle along the weld line having the circumferential shape regardless of the start-end position of the circumferential welding, and accordingly, the degree of freedom of the circumferential welding increases.

A circumferential welding method according to another aspect is a circumferential welding method for performing circumferential welding while a welding torch is moved with the welding torch located outside a weld line and with the welding torch inclined in a left-right direction with respect to the weld line by using a vertical articulated robot. A start-end position of the circumferential welding is set to a position on the weld line nearest to a position at which a robot body of the vertical articulated robot is installed, and the circumferential welding is performed while the welding torch is moved so as to draw a circular trajectory.

In the case where the circumferential welding is performed while the welding torch is moved with the welding torch located outside the weld line and with the welding torch inclined in the left-right direction with respect to the weld line by using the vertical articulated robot, the same posture of the welding torch is typically maintained with respect to a circumferential tangent. For this reason, the welding torch makes a full turn so as to follow an axis perpendicular to a circumferential surface as the position of welding changes along the circumference. To continue this rotation, mainly the sixth shaft of the robot body rotates, and it is necessary to continuously maintain taught trajectory that is not out of the range of the motion of this shaft during the welding. The present inventor has found that the vertical articulated robot enables the welding torch to move in a circle along the weld line having the circumferential shape by performing the circumferential welding method described above. Accordingly, the circumferential welding method described above enables welding to be continuously performed without suspending the welding during the circumferential welding.

A circumferential welding method according to another aspect is a circumferential welding method for performing circumferential welding while a welding torch is moved with the welding torch located inside a weld line and with the welding torch inclined in a left-right direction with respect to the weld line by using a vertical articulated robot. A start-end position of the circumferential welding is set to a position on the weld line farthest from a position at which a robot body of the vertical articulated robot is installed, and the circumferential welding is performed while the welding torch is moved so as to draw a circular trajectory.

In the case where the circumferential welding is performed while the welding torch is moved with the welding torch located inside the weld line and with the welding torch inclined in the left-right direction with respect to the weld line by using the vertical articulated robot, the same posture of the welding torch is typically maintained with respect to a circumferential tangent. For this reason, the welding torch makes a full turn so as to follow an axis perpendicular to a circumferential surface as the position of welding changes along the circumference. To continue this rotation, mainly the sixth shaft of the robot body rotates, and it is necessary to continuously maintain taught trajectory that is not out of the range of the motion of this shaft during the welding. The present inventor has found that the vertical articulated robot enables the welding torch to move in a circle along the weld line having the circumferential shape by performing the circumferential welding method described above. Accordingly, the circumferential welding method described above enables welding to be continuously performed without suspending the welding during the circumferential welding.

A circumferential welding method according to another aspect is a circumferential welding method for performing circumferential welding while a welding torch is moved with the welding torch located outside a weld line and with the welding torch inclined in a left-right direction with respect to the weld line by using a vertical articulated robot. A position at which a robot body of the vertical articulated robot is installed is set to a position on a second imaginary line that intersects a first imaginary line in a vertical direction outside the weld line having a circumferential shape and that has a distance from a start-end position of the circumferential welding shorter than a distance from a center of the weld line having the circumferential shape, the first imaginary line passing through the center and the start-end position. The circumferential welding is performed while the welding torch is moved so as to draw a circular trajectory.

In the case where the circumferential welding is performed while the welding torch is moved with the welding torch located outside the weld line and with the welding torch inclined in the left-right direction with respect to the weld line by using the vertical articulated robot, the same posture of the welding torch is typically maintained with respect to a circumferential tangent. For this reason, the welding torch makes a full turn so as to follow an axis perpendicular to a circumferential surface as the position of welding changes along the circumference. To continue this rotation, mainly the sixth shaft, of the robot, body rotates, and it is necessary to continuously maintain taught trajectory that is not out of the range of the motion of this shaft during the welding. The present inventor has found that the vertical articulated robot enables the welding torch to move in a circle along the weld line having the circumferential shape by performing the circumferential welding method described above. Accordingly, the circumferential welding method described above enables welding to be continuously performed without suspending the welding during the circumferential welding. The circumferential welding method described above performs the circumferential welding in the same manner as in the second circumferential welding method described above by changing the position at which the robot body is installed. The circumferential welding method described above is effective in the case where the start-end position of the circumferential welding cannot be changed.

A circumferential welding method according to another aspect is a circumferential welding method for performing circumferential welding while a welding torch is moved with the welding torch located inside a weld line and with the welding torch inclined in a left-right direction with respect to the weld line by using a vertical articulated robot. A position at which a robot body of the vertical articulated robot is installed is set to a position on a second imaginary line that intersects a first imaginary line in a vertical direction outside the weld line having a circumferential shape and that has a distance from a center of the weld line having the circumferential shape shorter than a distance from a start-end position of the circumferential welding, the first imaginary line passing through the center and the start-end position. The circumferential welding is performed while the welding torch is moved so as to draw a circular trajectory.

In the case where the circumferential welding is performed while the welding torch is moved with the welding torch located inside the weld line and with the welding torch inclined in the left-right direction with respect to the weld line by using the vertical articulated robot, the same posture of the welding torch is typically maintained with respect to a circumferential tangent. For this reason, the welding torch makes a full turn so as to follow an axis perpendicular to a circumferential surface as the position of welding changes along the circumference. To continue this rotation, mainly the sixth shaft of the robot body rotates, and it is necessary to continuously maintain taught trajectory that is not out of the range of the motion of this shaft during the welding. The present inventor has found that the vertical articulated robot enables the welding torch to move in a circle along the weld line having the circumferential shape by performing the circumferential welding method described above. Accordingly, the circumferential welding method described above enables welding to be continuously performed without suspending the welding during the circumferential welding. The circumferential welding method described above performs the circumferential welding in the same manner as in the third circumferential welding method described above by changing the position at which the robot body is installed. The circumferential welding method described above is effective in the case where the start-end position of the circumferential welding cannot be changed.

With the features described above, the circumferential welding is performed by using the offline teaching data for teaching the circumferential welding.

Teaching data (a teaching program) is needed to operate a robot in a teaching playback method. A production line is used to create the teaching data by using an actual robot, and accordingly, productivity decreases when the manufacturing line stops. In view of this, the teaching data is created by offline teaching with a computer without using an actual robot. The circumferential welding methods described above can be used for the circumferential welding in which the offline teaching data is used.

The present invention contains subject matter related to Japanese Patent Application No. 2020-53638 filed in the Japan Patent Office on Mar. 25, 2020, the entire contents of which are incorporated herein by reference.

The present invention is appropriately and sufficiently described above with reference to the drawings by using the embodiment to express the present invention. It should be recognized that the embodiment described above can be readily modified and/or improved by a person in the art. Accordingly, it is interpreted that a modified embodiment or an improved embodiment that is carried out by a person in the art is included in the scope of Claims, provided that the modified embodiment or the improved embodiment is not departed from the scope of Claims.

### INDUSTRIAL APPLICABILITY

According to the present invention, a circumferential welding method that enables circumferential welding to be performed in a circle by using a robot can be provided.

1. A circumferential welding method for performing circumferential welding of at least one of a V-shaped groove and an I-shaped groove while a welding torch is moved with the welding torch having a downward posture by using a vertical articulated robot,
wherein the circumferential welding is performed while a rotation angle of the welding torch is adjusted such that a wrist rotation center of a robot body of the vertical articulated robot is always located closer to a position at which the robot body is installed than the welding torch is, and the welding torch is moved so as to draw a circular trajectory.

2. A circumferential welding method for performing circumferential welding while a welding torch is moved with the welding torch located outside a weld line and with the welding torch inclined in a left-right direction with respect to the weld line by using a vertical articulated robot,
wherein a start-end position of the circumferential welding is set to a position on the weld line nearest to a position at which a robot body of the vertical articulated robot is installed, and the circumferential welding is performed while the welding torch is moved so as to draw a circular trajectory.

3. A circumferential welding method for performing circumferential welding while a welding torch is moved with the welding torch located inside a weld line and with the welding torch inclined in a left-right direction with respect to the weld line by using a vertical articulated robot,
wherein a start-end position of the circumferential welding is set to a position on the weld line farthest from a position at which a robot body of the vertical articulated robot is installed, and the circumferential welding is performed while the welding torch is moved so as to draw a circular trajectory.

4. A circumferential welding method for performing circumferential welding while a welding torch is moved with the welding torch located outside a weld line and with the welding torch inclined in a left-right direction with respect to the weld line by using a vertical articulated robot,
wherein a position at which a robot body of the vertical articulated robot is installed is set to a position on a second imaginary line that intersects a first imaginary line in a vertical direction outside the weld line having a circumferential shape and that has a distance from a start-end position of the circumferential welding shorter than a distance from a center of the weld line having the circumferential shape, the first imaginary line passing through the center and the start-end position, and
wherein the circumferential welding is performed while the welding torch is moved so as to draw a circular trajectory.

5. A circumferential welding method for performing circumferential welding while a welding torch is moved with the welding torch located inside a weld line and with the welding torch inclined in a left-right direction with respect to the weld line by using a vertical articulated robot,
wherein a position at which a robot body of the vertical articulated robot is installed is set to a position on a second imaginary line that intersects a first imaginary line in a vertical direction outside the weld line having a circumferential shape and that has a distance from a center of the weld line having the circumferential shape shorter than a distance from a start-end position of the circumferential welding, the first imaginary line passing through the center and the start-end position, and
wherein the circumferential welding is performed while the welding torch is moved so as to draw a circular trajectory.

6. The circumferential welding method according to claim 5, wherein the circumferential welding is performed by using offline teaching data for teaching the circumferential welding.

7. The circumferential welding method according to claim 1, wherein the circumferential welding is performed by using offline teaching data for teaching the circumferential welding.

8. The circumferential welding method according to claim 2, wherein the circumferential welding is performed by using offline teaching data for teaching the circumferential welding.

9. The circumferential welding method according to claim 3, wherein the circumferential welding is performed by using offline teaching data for teaching the circumferential welding.

10. The circumferential welding method according to claim 4, wherein the circumferential welding is performed by using offline teaching data for teaching the circumferential welding.
